(19) United States
(12) Patent Application Publication
(10) Pub. No.: US 2016/0338354 A1
(43) Pub. Date: Nov. 24, 2016

(54) (S)-ABSCISIC ACID DERIVATIVES FOR ENHANCED FRUIT AND VEGETABLE COLORATION

(71) Applicant: Valent BioSciences Corporation, Libertyville, IL (US)

(72) Inventors: Derek D. Woolard, Zion, IL (US); Gary T. Wang, Libertyville, IL (US); Rick Hopkins, Fresno, CA (US); Daniel C. Leep, Lindenhurst, IL (US); Gregory D. Venburg, Deerfield, IL (US)

(21) Appl. No.: 15/158,817

(22) Filed: May 19, 2016

Related U.S. Application Data
(60) Provisional application No. 62/163,626, filed on May 19, 2015.

(51) Int. Cl. A01N 37/42; A01N 57/20

(52) U.S. Cl. CPC A01N 37/42; A01N 57/20

(57) ABSTRACT

The present invention is directed to the treatment of fruits and vegetables with 3′-methyl-(S)-abscisic acid, 3′-propargyl-(S)-abscisic acid, and/or salts thereof in order to enhance the color of the fruits and vegetables.

### FIELD OF THE INVENTION

The present invention is directed to methods for enhancing fruit and vegetable coloration comprising applying (S)-abscisic acid derivatives to the plants.

### BACKGROUND OF THE INVENTION

Coloration is an important characteristic of commercially grown fruits and vegetables. Often fruits and vegetables that are ripe and nutrient-rich will not receive the market price they deserve due to surface aesthetics. Consumers desire fruits and vegetables that have aesthetically pleasing peels or skins. For example, consumers will select for purchase oranges that have bright orange and uniform peels over oranges with green splotches or pale coloration. Accordingly, fruits and vegetables with uniform and desirable color can command premium prices in the market.

Currently, there are two products commercially available for enhancing fruit and vegetable coloration. One of the products, Ethrel® (available from and a registered trademark of Bayer) contains ethephon. Ethephon (2-chloroethylphosphonic acid) is an ethylene precursor which is rapidly converted into ethylene in plants. While ethephon is effective at enhancing fruit coloration, it is difficult to apply to the fruits and vegetables, requires high application rates, and does not provide consistent results. In some areas, there is also concern about the safety of ethephon use.

The other commercially available product, ProTone (available from and a registered trademark of Valent BioSciences Corporation) contains (S)-abscisic acid. (S)-abscisic acid is a plant growth regulator that promotes plant or fruit maturity and color development by directly augmenting anthocyanin synthesis. While (S)-abscisic acid (“S-ABA”) is very effective at enhancing fruit coloration, relatively high concentrations must be used in order to achieve desired results.

Dyes have also been used in attempts to improve the coloration of fruits and vegetables. Adding dyes to the fruits and vegetables, however, is often unacceptable to the consumer.

Accordingly, there is a need for new methods for enhancing fruit and vegetable coloration in order to produce highly marketable fruits and vegetables. The new methods should be cost-effective for the growers and produce consistent and reliable coloration results.

### SUMMARY OF THE INVENTION

The present invention is directed to methods for enhancing coloration of fruits and vegetables other than grapes comprising applying 3′-methyl-(S)-abscisic acid, 3′-propargyl-(S)-abscisic acid, and salts thereof to the plants.

### DETAILED DESCRIPTION OF THE INVENTION

Recently, Applicant discovered new S-ABA derivatives (see U.S. patent application Ser. Nos. 62/022,037 and 14/593,597). Applicant determined that two derivatives were unexpectedly more potent than S-ABA. Specifically, these derivatives are (2Z,4E)-5-((S)-1-hydroxy-2,3,6,6-tetramethyl-4-oxocyclohex-2-en-1-yl)-3-methylpenta-2,4-dienoic acid (“3′-methyl-(S)-abscisic acid”) and (2Z,4E)-5-((S)-1-hydroxy-2,6,6-trimethyl-4-oxo-3-(prop-2-yn-1-yl)cyclohex-2-en-1-yl)-3-methylpenta-2,4-dienoic acid (“3′-propargyl-(S)-abscisic acid”). The structures of these derivatives are below:

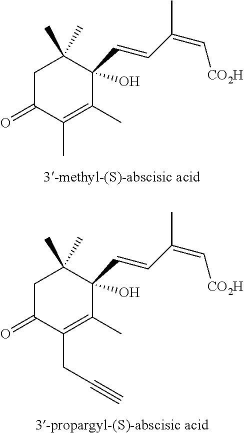

In an embodiment, the present invention is directed to methods for enhancing fruit coloration comprising applying an abscisic acid derivative selected from the group consisting of 3′-methyl-(S)-abscisic acid, 3′-propargyl-(S)-abscisic acid, and salts thereof to a fruit selected from the group consisting of apple, apricot, berries, dragon fruit, huckleberry, kiwifruit, mango, melon, muscadine, nectarine, orange, papaya, passionfruit, peach, pear, persimmon, plum, pluot, pomegranate, rhubarb, cherry, and tomato.

In another embodiment, the present invention is directed to methods for enhancing vegetable coloration comprising applying an abscisic acid derivative selected from the group consisting of 3′-methyl-(S)-abscisic acid, 3′-propargyl-(S)-abscisic acid, and salts thereof to a vegetable selected from the group consisting of beetroot, pepper, carrot, lettuce, potato, pumpkin, and sweet potato.

In a preferred embodiment, the abscisic acid derivative applied to the plant is 3′-methyl-(S)-abscisic acid.

In another embodiment, the abscisic acid derivative applied to the plant is 3′-propargyl-(S)-abscisic acid.

In an embodiment, the fruit is apples.

In an alternative embodiment, the fruit is apricots.

In a further embodiment, the fruit is berries. In a preferred embodiment, the berries are selected from the group consisting of blueberries, boysenberries, cape gooseberries, cloudberries, cranberries, huckleberries, and raspberries.

In an alternative embodiment, the fruit is dragon fruit.

In yet another embodiment, the fruit is kiwifruit.

In an embodiment, the fruit is mango.

In an alternative embodiment, the fruit is a melon. In a preferred embodiment, the melon is selected from the group consisting of cantaloupe and watermelon.

In an embodiment, the fruit is muscadine.

In a further embodiment, the fruit is nectarine.

In yet another embodiment, the fruit is orange.

In a further embodiment, the fruit is papaya.

In yet another embodiment, the fruit is passion fruit.

In an embodiment, the fruit is peach.

In an alternative embodiment, the fruit is pear.

In a further embodiment, the fruit is persimmon.

In yet another embodiment, the fruit is plum.

In an embodiment, the fruit is pluot.

In an alternative embodiment, the fruit is pomegranate.

In yet another embodiment, the fruit is rhubarb.

In an embodiment, the fruit is cherry. In a preferred embodiment, the cherry is selected from the group consisting of sweet cherry and sour cherry.

In a further embodiment, the fruit is tomato.

In an embodiment, the vegetable is beetroot.

In an alternative embodiment, the vegetable is pepper. In a preferred embodiment, the pepper is selected from the group consisting of bell pepper and hot pepper.

In a further embodiment, the vegetable is carrot.

In an embodiment, the vegetable is lettuce.

In an alternative embodiment, the vegetable is potato.

In a further embodiment, the vegetable is pumpkin.

In yet another embodiment, the vegetable is sweet potato.

In another embodiment, the 3′-methyl-(S)-abscisic acid and/or 3′-propargyl-(S)-abscisic acid is applied to the plant at a rate of from about 0.001 to about 100 mg per plant. In a preferred embodiment, the 3′-methyl-(S)-abscisic acid and/or 3′-propargyl-(S)-abscisic acid is applied to the plant at a rate of from about 0.01 to about 80 mg per plant. In a more preferred embodiment, the 3′-methyl-(S)-abscisic acid and/or 3′-propargyl-(S)-abscisic acid is applied to the plant at a rate of from about 0.01 to about 60 mg per plant.

In a further embodiment, the 3′-methyl-(S)-abscisic acid and/or 3′-propargyl-(S)-abscisic acid is applied to the plant with another plant growth regulator. In a preferred embodiment, the plant growth regulator is selected from the group consisting of cytokinins, gibberellins, auxins, and ethylene precursors. In a more preferred embodiment, the plant growth regulator is an ethylene precursor. In a preferred embodiment, the ethylene precursor is selected from the group consisting of ethephon or 1-aminocyclopropane carboxylic acid.

If ethephon is applied with 3′-methyl-(S)-abscisic acid and/or 3′-propargyl-(S)-abscisic acid, it may be applied at a rate of from about 1 to 400 grams per acre. In a preferred embodiment, the ethephon may be applied at a rate of from about 10 to 300 grams per acre. In a more preferred embodiment, it may be applied at a rate of from about 50 to 300 grams per acre.

The abscisic acid derivatives claimed herein are enantiomerically pure “(S)” derivatives, meaning that “(2Z,4E)-5-((S)-1-hydroxy-2,3,6,6-tetramethyl-4-oxocyclohex-2-en-1-yl)-3-methylpenta-2,4-dienoic acid,” “(2Z,4E)-5-((S)-1-hydroxy-2,6,6-trimethyl-4-oxo-3-(prop-2-yn-1-yl)cyclohex-2-en-1-yl)-3-methylpenta-2,4-dienoic acid,” “3′-propargyl-(S)-abscisic acid,” and “3′-methyl-(S)-abscisic acid” refer to derivatives comprising greater than 95% purity of the “(S)” enantiomer. This means that the compounds claimed herein are not “racemic” or “(±).” “Racemic” and “(±)” refer to derivatives with a relatively equal mixture of R/S enantiomers.

As used herein “salts” refers to those salts which retain the biological effectiveness and properties of the parent compounds and which are not biologically or otherwise harmful at the dosage administered. Salts of the compounds of the present inventions may be prepared from inorganic or organic acids or bases. Suitable salts include inorganic salts such as the ammonium, lithium, sodium, potassium, magnesium and calcium salts and organic amine salts such as the triethylamine, morpholine, triethanolamine, dimethylethanolamine and ethanolamine salts.

As used herein, all numerical values relating to amounts, weight percentages and the like are defined as “about” or “approximately” each particular value, namely, plus or minus 10% (±10%). For example, the phrase “at least 5% by weight” is to be understood as “at least 4.5% to 5.5% by weight.” Therefore, amounts within 10% of the claimed values are encompassed by the scope of the claims.

The articles “a,” “an” and “the” are intended to include the plural as well as the singular, unless the context clearly indicates otherwise.

1. A method of enhancing fruit coloration comprising applying an abscisic acid derivative selected from the group consisting of 3′-methyl-(S)-abscisic acid, 3′-propargyl-(S)-abscisic acid, and salts thereof to a fruit selected from the group consisting of apple, apricot, berries, dragon fruit, kiwifruit, mango, melon, muscadine, nectarine, orange, papaya, passionfruit, peach, pear, persimmon, plum, pluot, pomegranate, rhubarb, cherry, and tomato.

2. The method of claim 1 wherein the abscisic acid derivative is 3′-methyl-(S)-abscisic acid.

3. The method of claim 1 wherein the abscisic acid derivative is 3′-propargyl-(S)-abscisic acid.

4. The method of claim 2 wherein the 3′-methyl-(S)-abscisic acid is applied with a plant growth regulator selected from the group consisting of cytokinins, gibberellins, auxins, and ethylene precursors.

5. The method of claim 4 wherein the ethylene precursor is ethephon.

6. The method of claim 3 wherein the 3′-propargyl-(S)-abscisic acid is applied with a plant growth regulator selected from the group consisting of cytokinins, gibberellins, auxins, and ethylene precursors.

7. The method of claim 6 wherein the ethylene precursor is ethephon.

8. A method of enhancing vegetable coloration comprising applying an abscisic acid derivative selected from the group consisting of 3′-methyl-(S)-abscisic acid, 3′-propargyl-(S)-abscisic acid, and salts thereof to a vegetable selected from the group consisting of beetroot, pepper, carrot, lettuce, potato, pumpkin, and sweet potato.

9. The method of claim 8 wherein the abscisic acid derivative is 3′-methyl-(S)-abscisic acid.

10. The method of claim 8 wherein the abscisic acid derivative is 3′-propargyl-(S)-abscisic acid.

11. The method of claim 9 wherein the 3′-methyl-(S)-abscisic acid is applied with a plant growth regulator selected from the group consisting of cytokinins, gibberellins, auxins, and ethylene precursors.

12. The method of claim 11 wherein the ethylene precursor is ethephon.

13. The method of claim 10 wherein the 3′-propargyl-(S)-abscisic acid is applied with a plant growth regulator selected from the group consisting of cytokinins, gibberellins, auxins, and ethylene precursors.

14. The method of claim 13 wherein the ethylene precursor is ethephon.
